(19) United States
(12) Patent Application Publication
(10) Pub. No.: US 2002/0184058 A1
(43) Pub. Date: Dec. 5, 2002

(54) System, method and article of manufacture for managing project and insurance information

(76) Inventors: Nancy Simonson, Mendota Heights, MN (US); Kimberly Guentzel, Burnsville, MN (US); Deron Cowan, Newburgh, IN (US); Allan Fishel, Wayzata, MN (US)

Correspondence Address: MERCHANT & GOULD PC, P.O. BOX 2903, MINNEAPOLIS, MN, 55402-0903, US

(21) Appl. No.: 09/872,757

(22) Filed: Jun. 1, 2001

(51) Int. Cl. G06F 17/60

(52) U.S. Cl. 705/4

(57) ABSTRACT

A method of issuing an insurance policy for a wrap-up insurance program includes receiving initial data for a project; receiving subsequent data for a plurality of parties; and issuing an insurance policy for the plurality of parties; wherein receiving the initial data, receiving subsequent data, and issuing an insurance policy are performed by a single party. A method of managing project and insurance information includes receiving project information; receiving insurance information; linking the project information to the insurance information; and generating a comparison in real-time relative to the receipt of project and insurance information.

FIELD

The present invention relates to managing insurance information and more particularly to managing insurance and project information to generate insurance policies and real-time project comparisons.

### BACKGROUND

Insurance policies are issued to cover a variety of risks, including general liability and worker's compensation. During the course of a construction project, each contractor working on the project is required to carry proper insurance. Typically, this insurance is purchased by the individual contractor for their own benefit and protection, as well as the benefit and protection of others who sustain injury or loss as a consequence of their construction work. The cost of this insurance is passed onto the owner of the project through the contractor's bid for the project. These individual insurance policies can be costly.

In some instances, each contractor on the project can be insured by one insurance policy, typically issued to the owner or general contractor of the project, called a wrap-up insurance policy. A wrap-up insurance policy is a centralized and controlled insurance and loss control program for a particular construction project. The insurance is purchased and administered by the wrap-up manager and covers all participating contractors, subcontractors, and the owner.

Typically, an insurance customer goes to a broker to purchase insurance. The broker gathers the relevant initial information needed by an underwriter and sends the information to the underwriter. The underwriter will then issue a wrap-up insurance policy to the customer. As new contactors begin work, the broker collects subsequent information for the new contractors and sends it to the underwriter. Each step in this process requires information to be re-entered by each successive party.

In most instances, wrap-up insurance policies vary materially from project to project. As such, wrap-up insurance policies have disadvantages. One such disadvantage is the time required to issue a certificate of insurance to each new contractor starting work on the project. Another such disadvantage is the administration of the wrap-up insurance policy and its associated expense. Another such disadvantage is the redundancies inherent in the wrap-up insurance polices, including having to enter the same information in multiple systems. Therefore, improvements are desirable.

### SUMMARY

In accordance with the present invention, the above and other problems are solved by the following:

In one aspect of the present invention, a method of issuing an insurance policy for a wrap-up insurance program includes receiving initial data for a project; receiving subsequent data for a plurality of parties; and issuing an insurance policy for the plurality of parties; wherein receiving the initial data, receiving subsequent data, and issuing an insurance policy are performed by a single party.

In another aspect of the present invention, a computer program product readable by a computing system and encoding instructions for a computer process for issuing an insurance policy for a wrap-up program is disclosed.

In another aspect of the present invention, a system for issuing an insurance policy for a wrap-up insurance program includes a first receive module, a second receive module, and an issuance module. The first receive module receives initial data for the project. The second receive module receives subsequent data for a plurality of parties. The issuance module issues an insurance policy for the plurality of parties. The first and second receive modules and the issuance module are controlled by a single system.

In another aspect of the present invention, a method of managing project and insurance information includes receiving project information; receiving insurance information; linking the project information to the insurance information; and generating a comparison in real-time relative to the receipt of project and insurance information.

In another aspect of the present invention, a computer program product readable by a computing system and encoding instructions for a computer process for managing project and insurance information is disclosed.

In another aspect of the present information, a system for managing project and insurance information includes a first receive module, a second receive module, a link module, and a generate module. The first receive module receives project information. The second receive module receives insurance information. The link module links the project information to the insurance information. The generate module generates a comparison in real-time relative to the receipt of project and insurance information.

### DESCRIPTION OF THE DRAWINGS

The foregoing and other objects, aspects, and advantages are better understood from the following detailed description of a preferred embodiment of the invention with reference to the drawings, in which:

FIG. 1 is a schematic representation of a general policy issuance system according to aspects of the present disclosure;

FIG. 2 is a schematic representation of a general project information system according to aspects of the present disclosure;

FIG. 3 is a schematic representation of a computing system according to aspects of the present disclosure;

FIG. 4 is a schematic representation of a network-based processing system according to aspects of the present disclosure;

FIG. 5 is a schematic representation of an Internet-based processing system according to aspects of the present disclosure;

FIG. 6 is a schematic representation of a network server that may be used to according to aspects of the present disclosure;

FIG. 7 is a schematic representation of an HTTP packet that may be used to according to aspects of the present disclosure;

FIG. 8 is a flowchart illustrating a policy issuance system according to aspects of the present disclosure;

FIG. 9 is an example screen shot of initial data according to aspects of the present disclosure;

FIG. 10 is an example screen shot of subsequent data according to aspects of the present disclosure;

FIG. 11 is a schematic diagram of example components of an insurance management system according to aspects of the present disclosure;

FIG. 12 is an example screen shot of a deal module according to aspects of the present disclosure;

FIG. 13 is an example screen shot of a deal module according to aspects of the present disclosure;

FIG. 14 is an example screen shot of a deal module according to aspects of the present disclosure;

FIG. 15 is an example screen shot of benchmark rates according to aspects of the present disclosure;

FIG. 16 is an example screen shot of a contractors module according to aspects of the present disclosure;

FIG. 17 is an example screen shot of information in a payroll module according to aspects of the present disclosure; and

FIG. 18 is a flowchart illustrating the logical operations of an insurance management system according to aspects of the present disclosure.

### DETAILED DESCRIPTION

In the following description of preferred embodiments of the present invention, reference is made to the accompanying drawings that form a part hereof, and in which is shown by way of illustration specific embodiments in which the invention may be practiced. It is understood that other embodiments may be utilized and structural changes may be made without departing from the scope of the present invention.

In general, the present disclosure describes methods, systems, and an article of manufacture containing the methods for managing insurance and project information. In general, a policy issuance system uses initial and subsequent data to issue an insurance policy. A management system uses project and insurance information to generate a real-time comparison between estimated and actual.

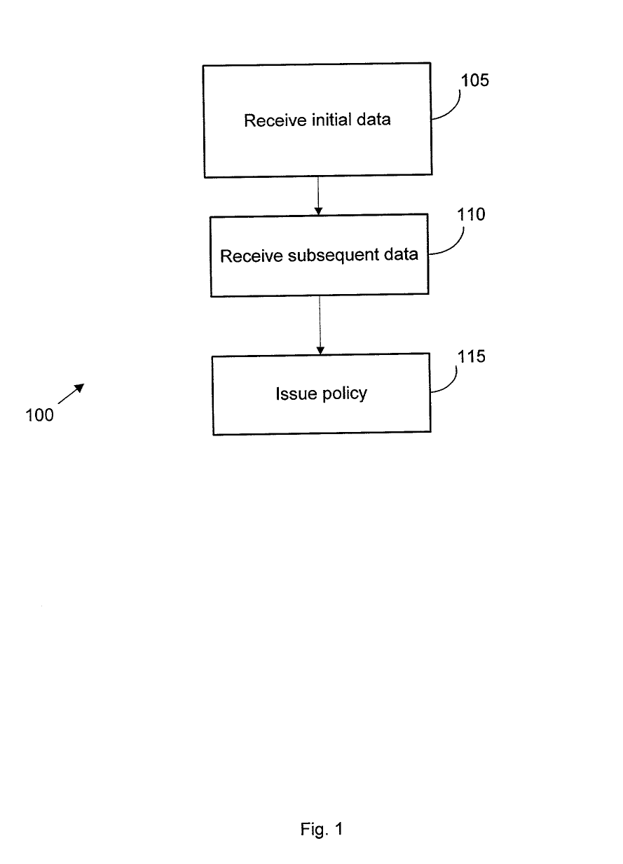

Referring now to FIG. 1, a schematic representation of a policy issuance system 100 is illustrated. A first receive module 105 receives initial data for a project. This initial data might include, for example, the location of the project, the owner of the project, and the general contractor of the project. A second receive module 110 receives subsequent data for at least one party, for example, a subcontractor. A policy module 115 issues an insurance policy for the at least one party, for example, the subcontractor.

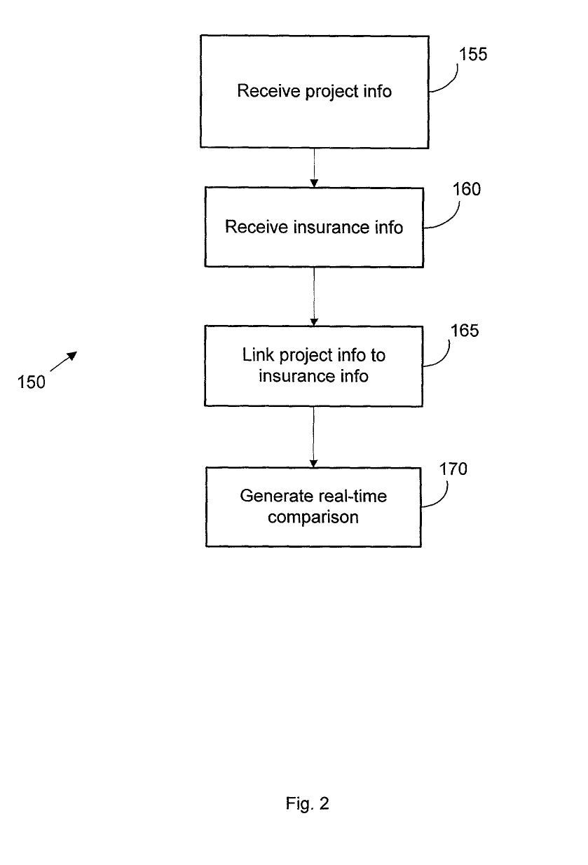

Referring now to FIG. 2, a schematic representation of a management system 155 is illustrated. A first receive module 155 receives project information. This information might include, for example, initial projections and intermittent real-time costs. A second receive module 160 receives insurance information. This information might include, for example, initial worker's compensation benchmarks and subsequent changes in worker's compensation benchmarks. A link module 165 links project information to insurance information. A generate module 170 generates real-time comparisons of project and insurance information. For example, the generate module 170 might generate a comparison of real-time payroll costs to projected payroll costs.

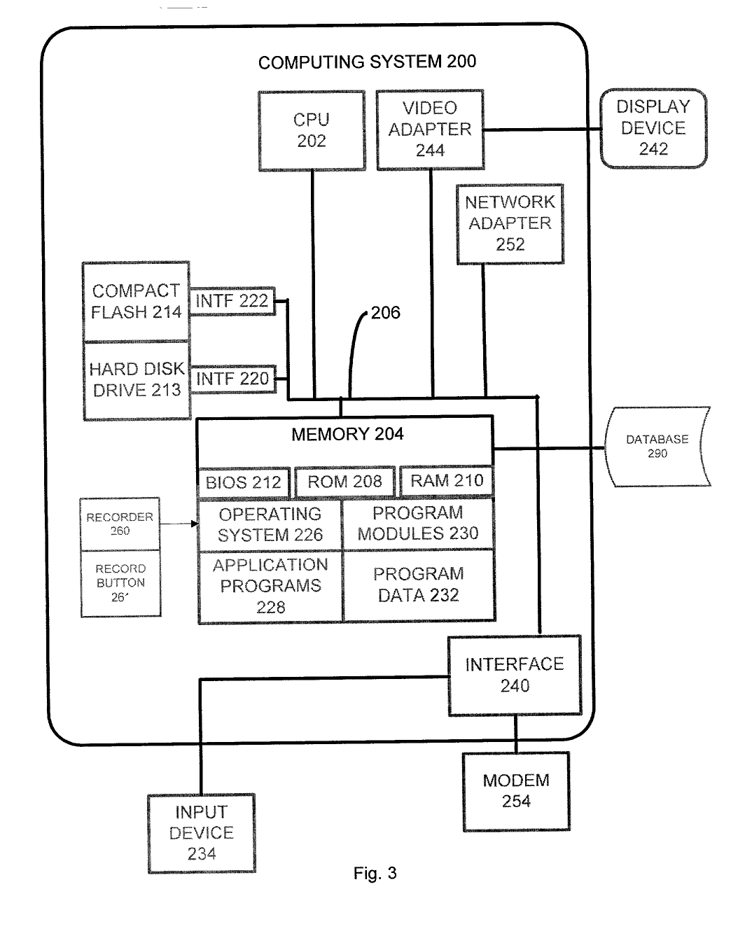

FIG. 3 and the following discussion are intended to provide a brief, general description of a suitable computing environment in which the invention might be implemented. Although not required, the invention is described in the general context of computer-executable instructions, such as program modules, being executed by a computing system, such as an IBM compatible personal computer, Apple Macintosh computer, or a UNIX-based workstation. Generally, program modules include routines, programs, objects, components, data structures, etc. that perform particular tasks or implement particular abstract data types.

Those skilled in the art will appreciate that the invention might be practiced with other computer system configurations, including handheld devices, palm devices, multiprocessor systems, microprocessor-based or programmable consumer electronics, network personal computers, minicomputers, mainframe computers, and the like. The invention might also be practiced in distributed computing environments where tasks are performed by remote processing devices that are linked through a communications network. In a distributed computing environment, program modules might be located in both local and remote memory storage devices.

Referring now to FIG. 3, an exemplary environment for implementing embodiments of the present invention includes a general purpose computing device in the form of a computing system 200, including at least one processing system 202. A variety of processing units are available from a variety of manufacturers, for example, Intel or Advanced Micro Devices. The computing system 200 also includes a system memory 204, and a system bus 206 that couples various system components including the system memory 204 to the processing unit 202. The system bus 206 might be any of several types of bus structures including a memory bus, or memory controller; a peripheral bus; and a local bus using any of a variety of bus architectures.

Preferably, the system memory 204 includes read only memory (ROM) 208 and random access memory (RAM) 210. A basic input/output system 212 (BIOS), containing the basic routines that help transfer information between elements within the computing system 200, such as during start-up, is typically stored in the ROM 208.

Preferably, the computing system 200 further includes a secondary storage device 213, such as a hard disk drive, for reading from and writing to a hard disk (not shown), and a compact flash card 214.

The hard disk drive 213 and compact flash card 214 are connected to the system bus 206 by a hard disk drive interface 220 and a compact flash card interface 222, respectively. The drives and cards and their associated computer-readable media provide nonvolatile storage of computer readable instructions, data structures, program modules and other data for the computing system 200.

Although the exemplary environment described herein employs a hard disk drive 213 and a compact flash card 214, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 213, compact flash card 214, ROM 208, or RAM 210, including an operating system 226, one or more application programs 228, other program modules 230, and program data 232. A user might enter commands and information into the computing system 200 through an input device 234. Examples of input devices might include a keyboard, mouse, microphone, joystick, game pad, satellite dish, scanner, touchpad, and a telephone. These and other input devices are often connected to the processing unit 202 through an interface 240 that is coupled to the system bus 206. These input devices also might be connected by any number of interfaces, such as a parallel port, serial port, game port, or a universal serial bus (USB). A display device 242, such as a monitor, is also connected to the system bus 206 via an interface, such as a video adapter 244. The display device 242 might be internal or external. In addition to the display device 242, computing systems, in general, typically include other peripheral devices (not shown), such as speakers, printers, and palm devices.

When used in a LAN networking environment, the computing system 200 is connected to the local network through a network interface or adapter 252. When used in a WAN networking environment, such as the Internet, the computing system 200 typically includes a modem 254, the network interface, or other means, such as a direct connection, for establishing communications over the wide area network. The modem 254, which can be internal or external, is connected to the system bus 206 via the interface 240. In a networked environment, program modules depicted relative to the computing system 200, or portions thereof, may be stored in a remote memory storage device. It will be appreciated that the network connections shown are exemplary and other means of establishing a communications link between the computing systems may be used.

The computing system 200 might also include a recorder 260 connected to the memory 204. The recorder 260 includes a microphone for receiving sound input and is in communication with the memory 204 for buffering and storing the sound input. Preferably, the recorder 260 also includes a record button 261 for activating the microphone and communicating the sound input to the memory 204.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a supplier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

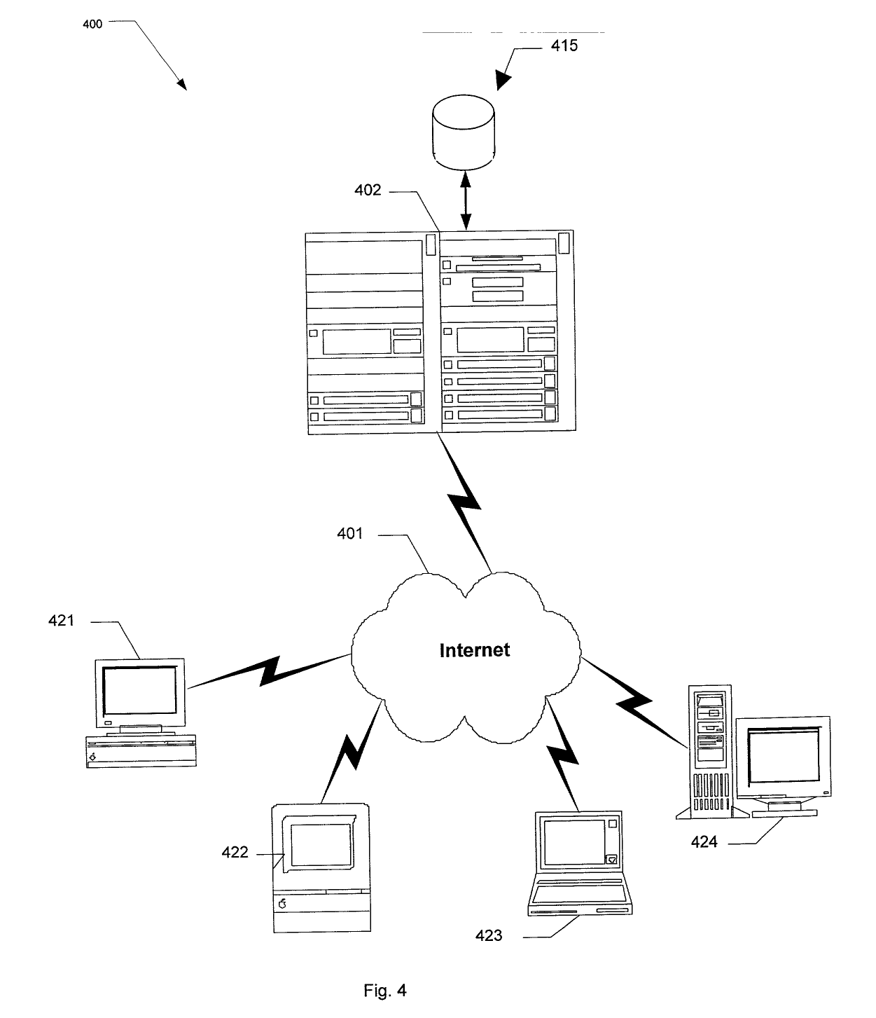

FIG. 4 illustrates a network based processing system providing processing services to remote clients according to one example embodiment of the present disclosure. Remote users use client processors 421-424, such as the computing system 200 described above, to communicate over a communications network like the Internet 401 to communicate to one or more server processors 402, such as the computing system 200 described above, to obtain data and processing services.

In general, the Internet is composed of a great number of individual networks, together forming a global connection of thousands of computer systems. After understanding that machines are connected to the individual networks, we can investigate how the networks are connected together to form an inter-network, or an internet.

In terms of architecture, two given networks are connected by a computer that attaches to both of them. Internet gateways and routers provide the interconnection necessary to send packets between networks and thus make connections possible. Without these links, data communication through the Internet would not be possible, as the information either would not reach its destination or would be incomprehensible upon arrival. A gateway might be thought of as an entrance to a communications network that performs code and protocol conversion between two otherwise incompatible networks. For instance, gateways transfer electronic mail and data files between networks over the internet.

IP Routers are also computers that connect networks. These routers must make decisions as to how to send the data packets the router receives to its destination through the use of continually updated routing tables. By analyzing the destination network address of the packets, routers make these decisions. Importantly, a router does not generally need to decide which host or end user will receive a packet; instead, a router seeks only the destination network and thus keeps track of information sufficient to get to the appropriate network, not necessarily the appropriate end user. Therefore, routers do not need to be huge supercomputing systems and are often just machines with small main memories and little disk storage. The distinction between gateways and routers is slight, and current usage blurs the line to the extent that the two terms are often used interchangeably. In current terminology, a gateway moves data between different protocols and a router moves data between different networks. So a system that moves mail between TCP/IP and OSI is a gateway, but a traditional IP gateway (that connects different networks) is a router.

In packet switching systems, routing is the process of choosing a path over which to send packets. As mentioned before, routers are the computers that make such choices. For the routing of information from one host within a network to another host on the same network, the datagrams that are sent do not actually reach the Internet backbone. This is an example of internal routing, which is completely self-contained within the network. The machines outside of the network do not participate in these internal routing decisions.

Indirect delivery is necessary when more than one physical network is involved, in particular when a machine on one network wishes to communicate with a machine on another network. This type of communication is what we think of when we speak of routing information across the Internet backbone. In indirect delivery, routers are required. To send a datagram, the sender must identify a router to which the datagram can be sent, and the router then forwards the datagram towards the destination network. Recall that routers generally do not keep track of the individual host addresses (of which there are millions), but rather just keeps track of physical networks (of which there are thousands). Essentially, routers in the Internet form a cooperative, interconnected structure, and datagrams pass from router to router across the backbone until they reach a router that can deliver the datagram directly.

In a similar fashion to that of the Internet described above, other networks, such as LAN's or WAN's use routers, or switches to route data.

Web servers typically have provided a mechanism to permit content data to be displayed within a web browser running on a remote client. Over time, this content data has evolved to include static pages, dynamically created pages, and pages that include programmable functionality that executes within the framework of the browser. This data exchange model in which a user interface is projected across the web using a web browser to transfer a “page” of data to be displayed to the user.

Remote servers 402, need to provide remote execution of processing functions that may reside on a server. Instead of processing database queries and similar data retrieval operations upon data that is resident on the server, servers need to receive a block of input data, process a function upon the data, and return a resultant set of data. If web servers 402 provide an interface that allows remote client processes to execute functions resident on the servers using the web as a communications mechanism, these servers can provide the equivalent functionality to a remote procedure call to processing functions resident on the server using currently used Internet communications mechanisms.

Any processing can be implemented using the above processing models. The complexity of the processing performed by the web service could be limitless, depending upon the processing power of the servers, the data to be processed, and the amount of time a client will reasonably wait for a response. Similarly, any database that provides data to a processing system, and any number of different databases, can be used in such a system. The server and client simply need to express the request data format, the response data format, and the processing to be performed in a same manner.

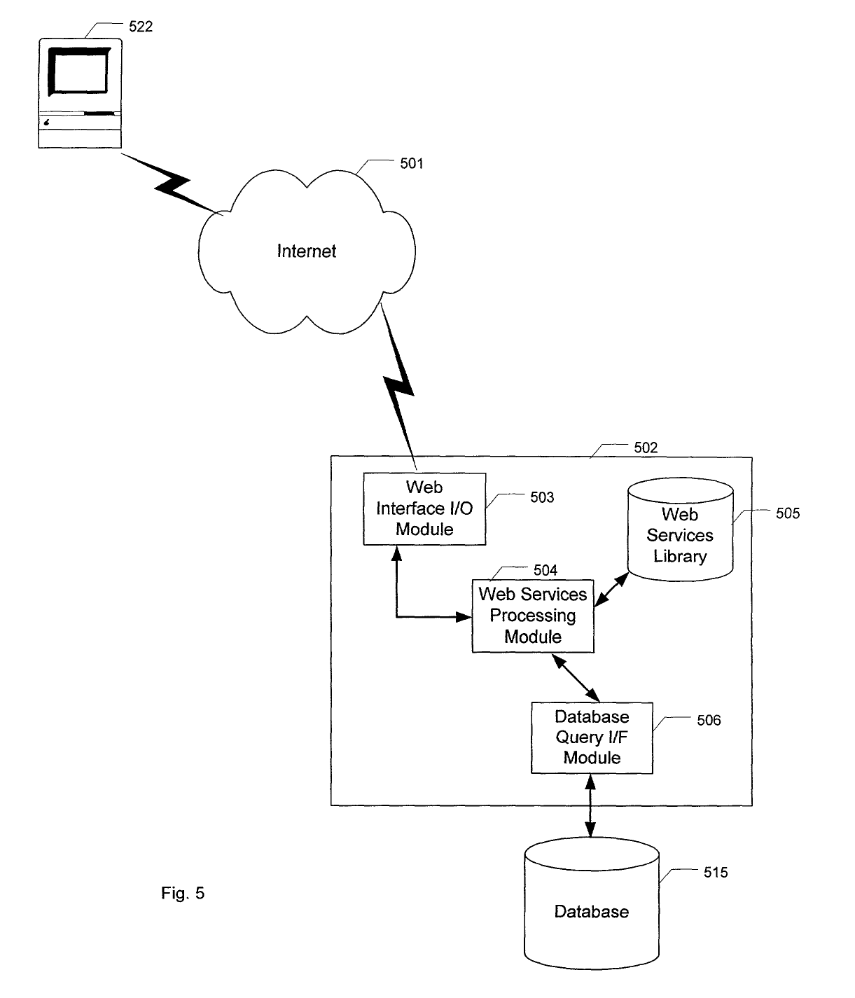

FIG. 5 illustrates an Internet based processing system providing processing services to remote users according to another example embodiment of the present disclosure. A remote client 522 communicates to a server 502 over a communications network 502 to transmit a web service request and receive a corresponding response. In an example embodiment, this communication is performed using the well known HTTP communications protocol. Any request/response communications protocol could be used without deviating from the spirit and scope of the present disclosure as recited in the attached claims.

Within the server 502, a web server I/O module 501 provides the communication processing necessary to communicate with the remote client 522. The web server I/O module 503 receives the incoming request, extracts the relevant data from the request and passes the request to a Web services processing module 504, and returns the response generated by the web services processing module 504 to the client 522. The web services processing module 504 is responsible for conforming the data to the relevant communications protocol.

The web services processing module 504 accepts the requests from the I/O module 503 and generates a response. The processing module 504 uses processing modules contained within a web services library 505 to perform the web services processing request. The processing module 504 also retrieves any data needed to perform the processing request from one or more databases 515 using a database query interface module 506. The database query interface module 506 performs the communication functions between the server 502 and the database 515. The database query interface module 506 also performs any data formatting functions necessary to present the needed data to the processing module 504 in a usable format.

Once the processing module 504 has generated the response corresponding to the requested web service, the response is sent back to the client 522 using the web interface I/O module 503.

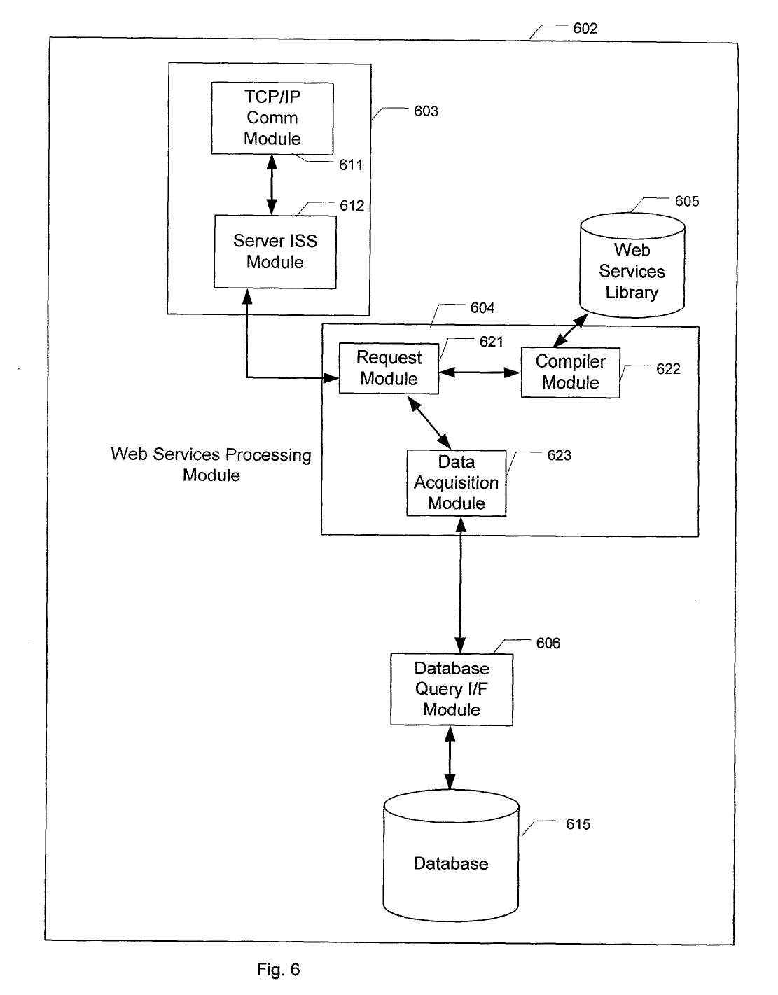

FIG. 6 illustrates a network server providing processing services to remote users according to yet another example embodiment of the present disclosure. The server 602 consists of the web interface I/O module 603 that contains a TCP/IP communications module 611 and a server ISS module 612 to perform its web communications function. The TCP/IP communications module 611 receives TCP/IP communications data packets and determines which packets correspond to web server requests. These web server requests are sent to a Server ISS module for processing.

The Server ISS module 612 receives these request packets that typically contain a URL that identifies the identity of the request, and the data corresponding to the request that is to be processed. If the Server ISS module 612 determines that the URL corresponds to a web service request, the request is sent to the web services processing module 604 for handling. The ISS Server module 612 may also receive other types of requests such as ASP, CGI and other web server requests that are handled by other functions not part of the present disclosure.

The web services processing module 604 consists of a request module 621, a compiler module 622, and a data acquisition module 623. The request module 621 receives the incoming web services request and determines whether the requested web service edits on the server 602 and if it is contained within the web services library 605 for use in generating the response to the incoming request. Because the request is provided in the form of a URL, the request typically corresponds to a file that contains instructions providing the processing to be performed. This file may contain human readable source code in any programming language. This file may contain any number of processing modules and exposed web services that may be accessed by a client.

The request module 621 determines whether this file has been previously compiled and stored within the web services library 605. If the file has been compiled, and if the compiled version corresponds to the current version of the URL file, the processing object module stored in the library is retrieved for use in servicing the incoming request. If the URL file has not been compiled, or if the URL has been modified since the file was compiled, a compiler module 622 is used to compile the URL file into a executable processing object module. The compiler module 622 compiles the current version of the URL file, stored the newly compiled object within the library 605 for later use, and passes the compiled object to the request module 621 for processing.

Once the request module 621 received the executable processing object module, the request module 621 services the incoming request by executing the executable processing module using any input data provided with the incoming request. If the executable processing module requests data from a database 615 as part of its operation, the request module sends a data request to the data acquisition module 623. This data module 623 obtains the needed data using the database query interface module 606 as discussed above and returns the data to the request module 621 for use by the executable processing object.

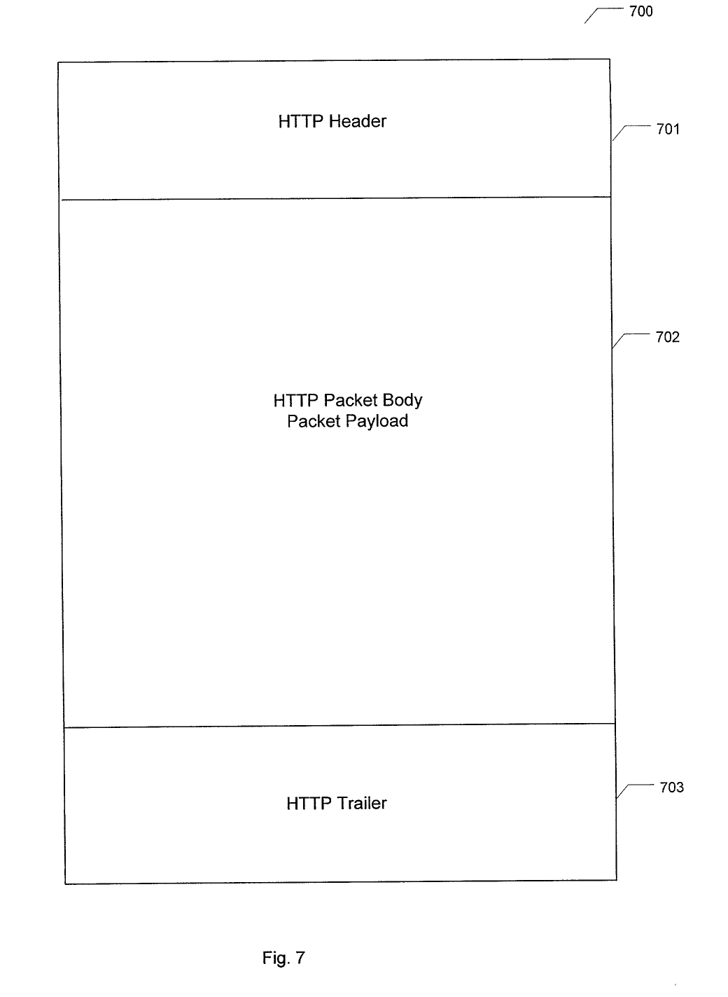

FIG. 7 illustrates an HTTP packet used by a network server providing processing services to remote users according to an example embodiment of the present disclosure. The HTTP Packet 700 contains a HTTP header 701 and HTTP trailer 703 to perform the standard HTTP communications function. The HTTP header typical contains information relating to the URL of the request, information regarding the identity and type of requesting client, and return address information associated with the client for sending a response to the request.

The HTTP Packet 700 also contains a Packet Body Payload 702 that contains information to be used in the request. In cases where a web service is requested by the packet, the packet body payload 702 contains a textual description of the web service request and any data to be processed as part of the web services request.

Below is a more detailed discussion of methods, systems, and an article manufacture containing the methods for managing insurance and project information. These methods can be practiced using a computing system as described in connection with FIG. 3, using an Internet environment as described in connection with FIGS. 4-7, and/or some other suitable environment. Typically, a user-interface for these methods will be executed on a client system with the data being stored and manipulated on a server system. Therefore, a particular user need only have a browser installed on their computing system or client system. Of course, many other configurations can be used to practice the invention as described in the claims. Using computing systems in this fashion is advantageous because it allows information, or data, to be disseminated to multiple parties quickly.

Preferably, the herein described methods and systems are implemented using Lotus Notes. Of course, one skilled in the art will recognize that the methods and systems could be implemented using any suitable application or other programming methodologies.

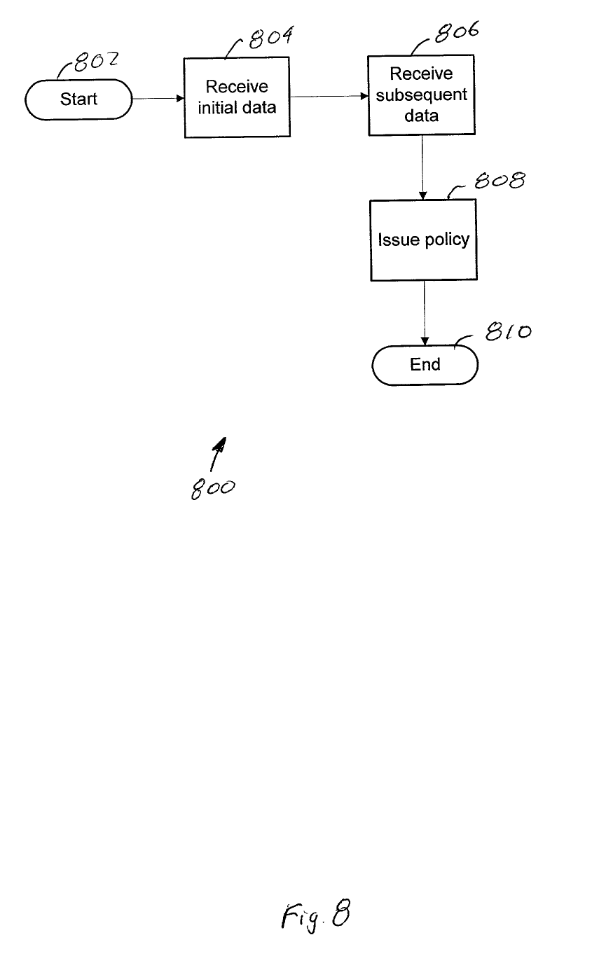

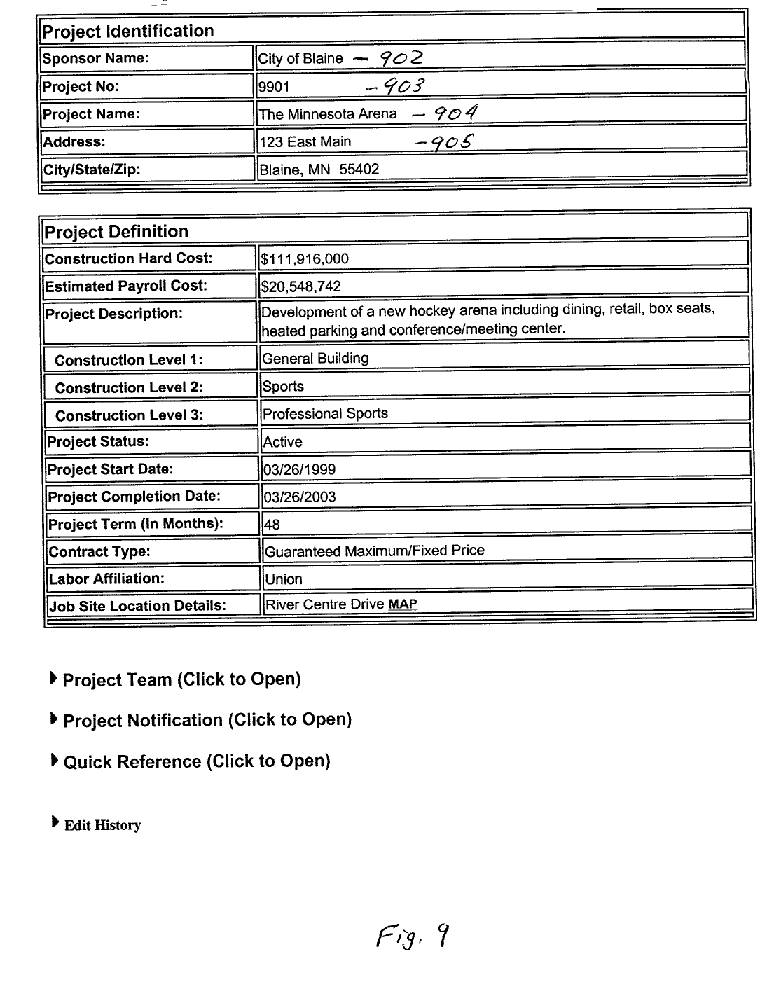

FIG. 8 illustrates an example operational flow for a policy issuance system 800. FIG. 8 is a flow chart representing logical operations of the policy issuance system 800. Entrance to the operational flow begins at a flow connection 802. A receive module 804 receives initial data, or information. Typically this initial data is project identification data necessary to insure a customer under a wrap-up insurance policy. FIG. 9 illustrates an example screen shot of project identification data initially used by the policy issuance system 800.

Referring now to FIG. 9, typical initial project identification data includes the client or sponsor's name 902, project number 903, project name 904, and project address 905. The data also might include construction hard cost, estimated payroll cost, a project description, project status, project start date, project completion data, project term, contract type, labor affiliation, and job site location details as illustrated in FIG. 9. Of course, other data could be included as well.

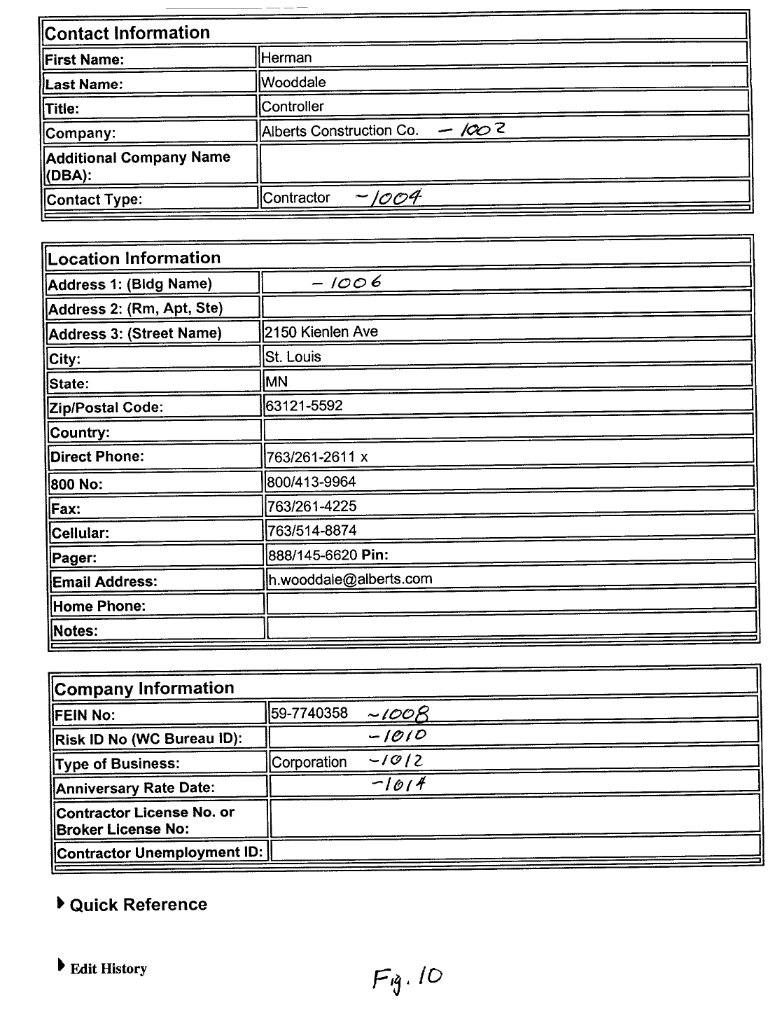

Referring back to FIG. 8, a receive module 806 receives subsequent data. Typically this subsequent data is data regarding a party for which an insurance policy is being issued. FIG. 10 illustrates an example screen shot of subsequent data used by the policy issuance system 800.

Referring now to FIG. 10, in most instances, the subsequent data includes data required to issue an insurance policy. This data might include the company name 1002, contact type 1004, company address 1006, the company's Federal Employer Identification Number (FEIN No.) 1008, risk identification number 1010, the type of business 1012, and the anniversary rate data 1014. The subsequent data might also include a contact name, phone number, fax number, email address, contractor license number, or contractor unemployment identification. Of course, other data could be included as well.

Referring back to FIG. 8, an issue module 808 issues an insurance policy for the particular party, or contractor, for which subsequent data was received by the receive module 806. It is noted that whenever information is entered in this disclosure, it is understood that the information could be entered manually or received electronically from another system or received from the same system. Operational flow ends at termination point 810.

The operational flow described in connection with FIG. 8 may best be understood in terms of an application example. Operational flow begins at start point 802. The first receive module 804 receives project identification data, as illustrated in FIG. 9, including the client or sponsor name 902, City of Blaine; and the project name 904, the Minnesota Arena. In this application example, the identification data is manually entered into the system 800.

The second receive module 806 receives subsequent data, as illustrated in FIG. 10, including the company name 1002, Alberts Construction Company; contact type 1004, Contractor; address 1006, 2150 Kienlen Avenue, St. Louis Park, Minn. 63121-5592; FEIN No., 59-7740358; and type of business 1012, corporation. In this application example, the subsequent data is received from a remote computing system into the policy issuance system 800.

The issue module 808 issues an insurance policy, or certificate, for Alberts Construction Company for the Minnesota Arena. Operational flow terminates at end point 810.

In one example embodiment, the policy issuance system 800 discussed above is implemented in a computing network environment previously discussed. Data is received from at least one client computing system into a database associated with a server. This is typically implemented over the Internet as an electronic commerce application. It is noted that there are numerous other methods of implementing the policy issuance system 800. For example, the policy issuance system 800 could be implemented using a single computing system or without a computing system at all.

The policy issuance system 800 discussed above has numerous advantages. One such advantage is that several redundancies are avoided. For example, once the project identification data is received, it does not need to be received for each successive insurance policy that is issued. In addition, once the subsequent data is received, it does not need to be received for other uses that will be described in more detail below. Another such advantage is that entered information can be disseminated to multiple parties quickly and that the insurance policy can be issued quicker or on-site.

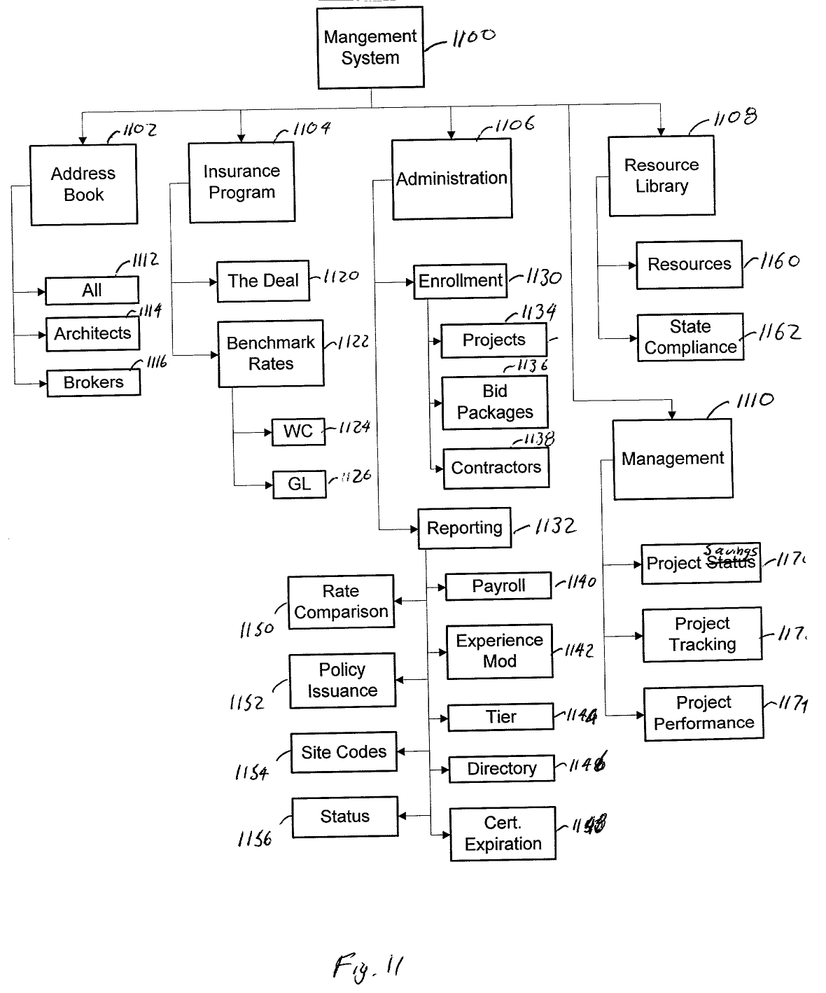

FIG. 11 is a schematic diagram of example components of an insurance management system 1100. In this example, the insurance management system 1100 includes an address book module 1102, an insurance program module 1104, an administration module 1106, a resource library 1108, and a management module 1110. The address book module 1102 includes a plurality of modules, for example, an all module 1112, an architect module 1114, and a broker module 1116. The all module 1112 contains all of the project contact information stored by the system. The architect module 1114 contains all of the contact information for architects associated with the project, and the broker module 1116 contains all of the contact information for brokers associated with the project. Of course, numerous other address modules might be included.

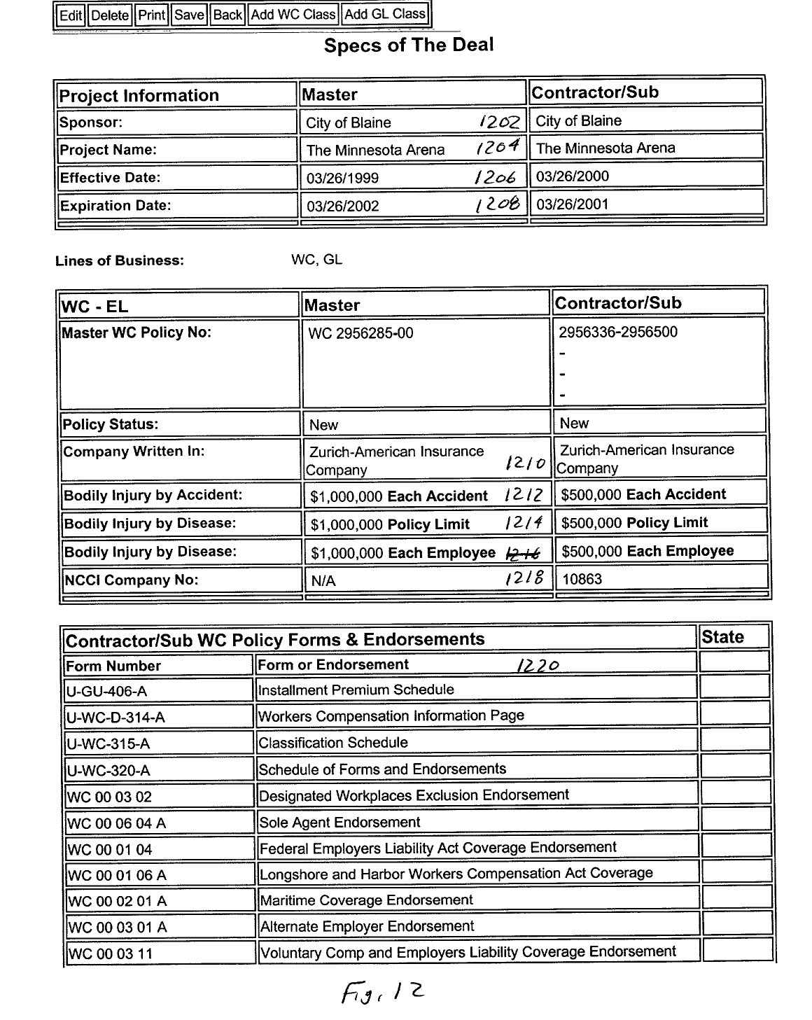

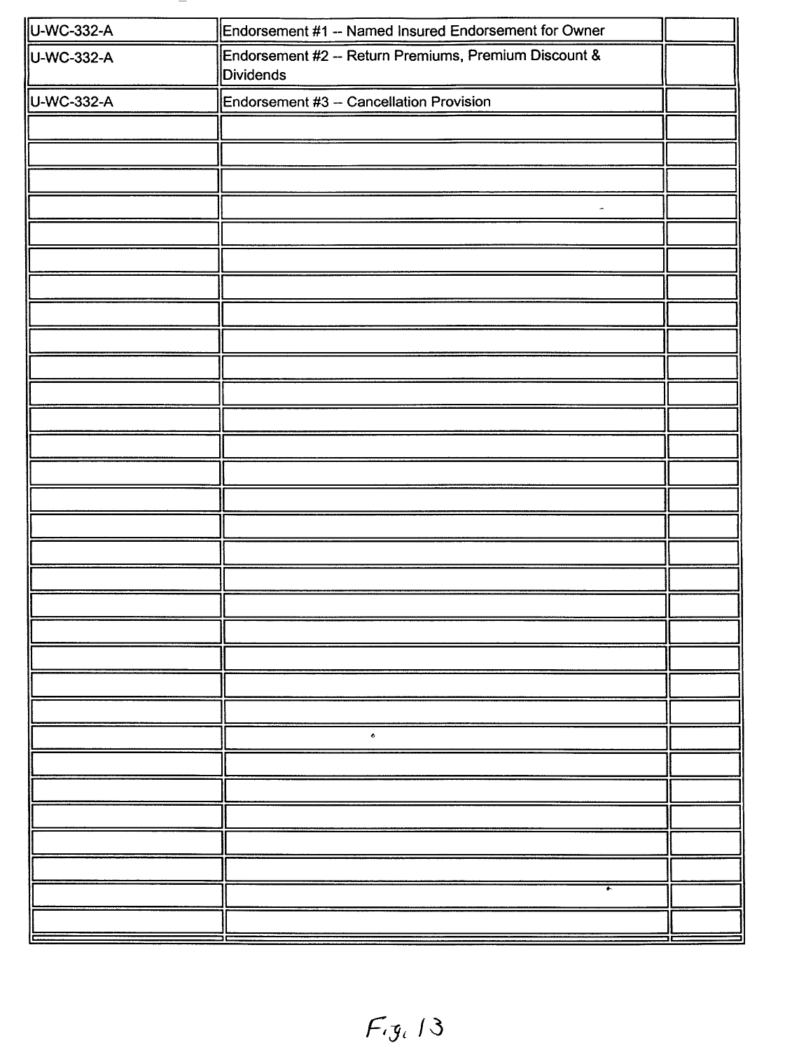

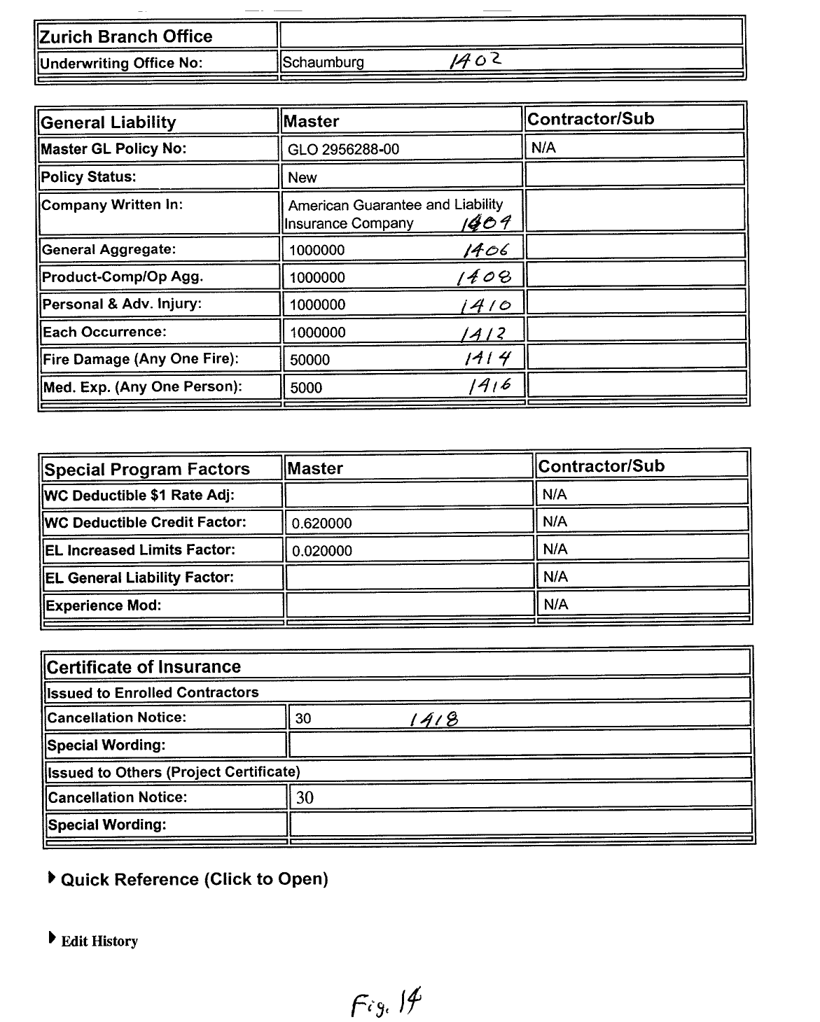

The insurance program module 1104 includes a deal module 1120 and a benchmark rate module 1122. The deal module 1120 typically outlines the specifications of the wrap-up insurance policy, or in other words, is a recap of what an underwriter for the insurance company sold for the project. FIGS. 12-14, illustrate example screen shots from a deal module. Referring now to FIGS. 12-14, the deal module 1120 includes a sponsor 1202, a project name 1204, and effective date 1206, and expiration date 1208, c company written in 1210, a bodily injury by accident 1212, a bodily injury by disease 1214, an NCCI company number 1218 a form number 1220, an underwriting office number 1402, a company written in 1404, a general aggregate 1406, product comp 1408, and many other data fields.

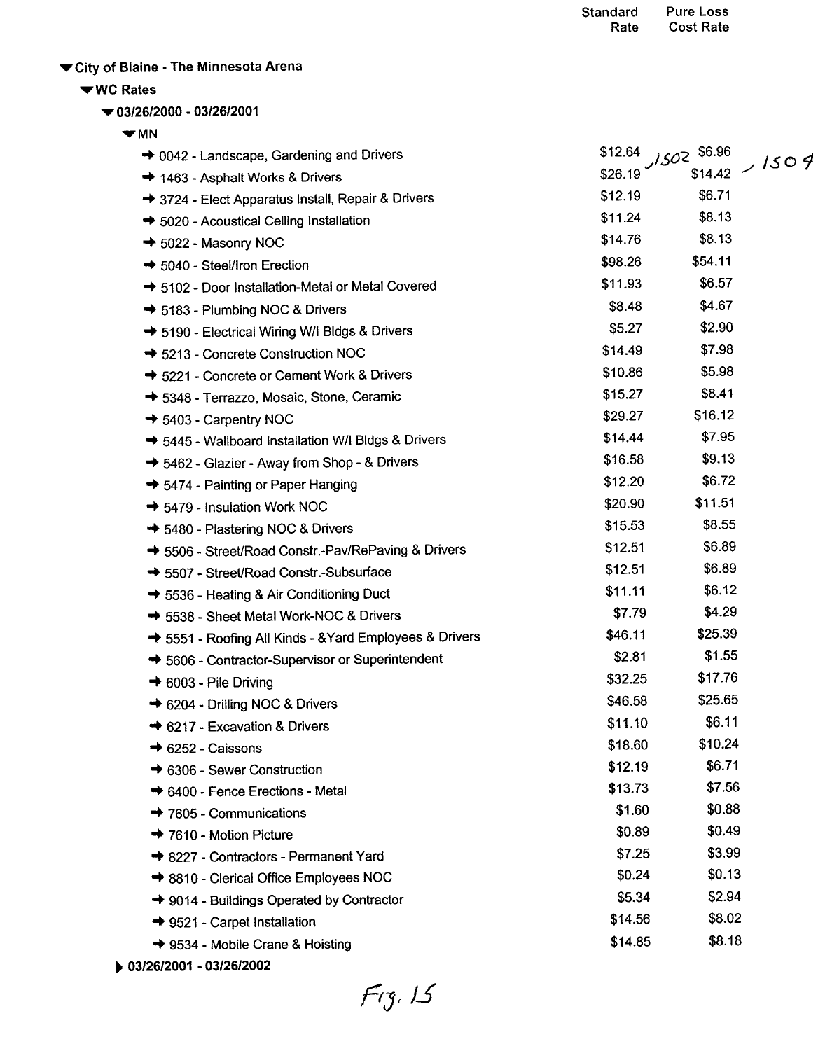

Referring back to FIG. 11, the benchmark rates module 1122 includes rates that are used in determining the premium for the wrap-up policy. The benchmark rates module 1122 includes a worker's compensation module 1124 and a general liability module 1126. The worker's compensation module 1124 includes the benchmark worker's compensation rates. FIG. 15 is an example screen shot of benchmark worker's compensation rates. For example, the standard rate 1502 for an asphalt worker is $26.19 and the pure loss cost rate 1504 is $14.42. Referring back to FIG. 11, likewise, the general liability module 1126 includes the benchmark general liability rates. Of course, numerous other benchmark rate modules might exist.

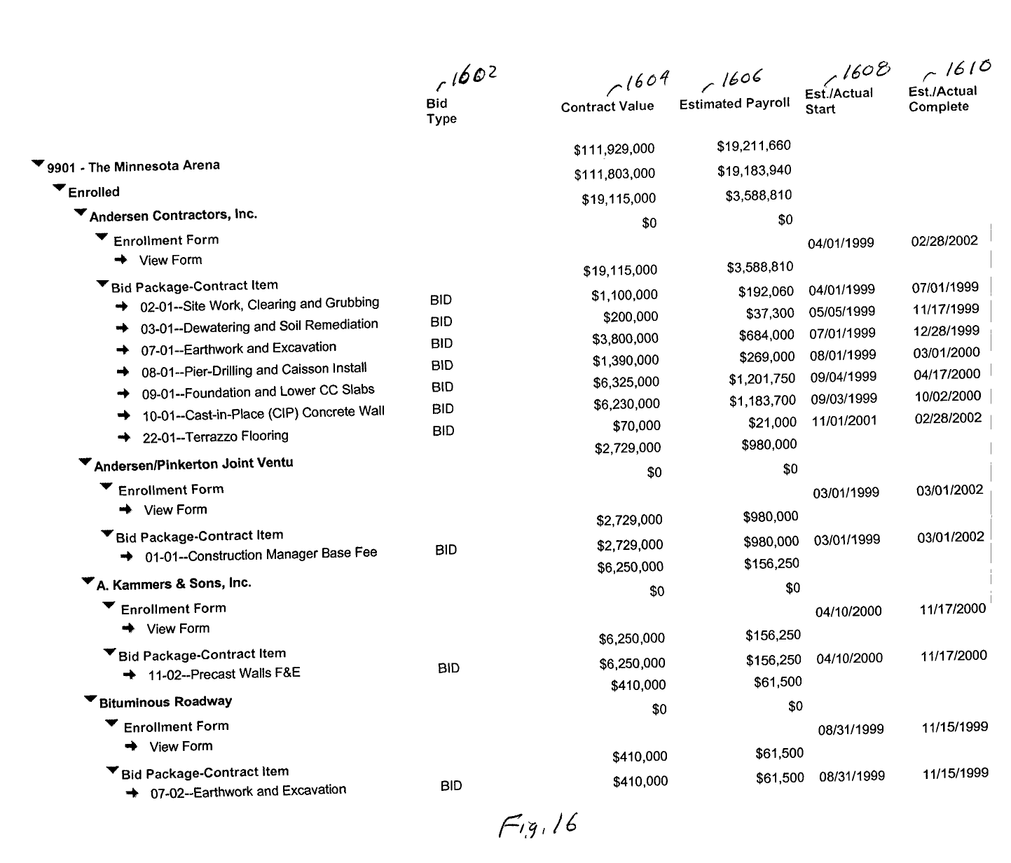

The administration module 1106 contains many sub-modules for the administration of the management system 1100. Typically, the administration module 1106 includes an enrollment module 1130 and a reporting module 1132. The enrollment module 1130 includes a project module 1134, a bid package module 1136, and a contractors module 1138. The project module 1134 shows all the projects currently active for a particular group of projects. Each project under the project module 1134 includes information such as the estimated total cost, estimated total payroll, and project status. The bid package module 1136 includes, for example, estimated engineers costs, bid package available date, pre-bid meeting date, bid date, and contract award date. The contractors module 1138 includes the bid type, contract value, estimated payroll, estimated or actual start date, and estimated or actual completion date. FIG. 16 illustrates an example screen shot of information included within the contractors module 1138. For example, the contractors module 1138 includes a bit-type data field 1602, a contract value 1604, estimated payroll 1606, estimated actual start 1608, and estimated/actual complete 1610.

The reporting module 1132 includes several sub-modules for reporting on or monitoring the project. Typically, the reporting module 1132 includes a payroll module 1140, an experience modification module 1142, a tier module 1144, a directory module 1146, a certificate expiration module 1148, a rate comparison module 1150, a policy issuance module 1152, a site codes module 1154, and status module 1156.

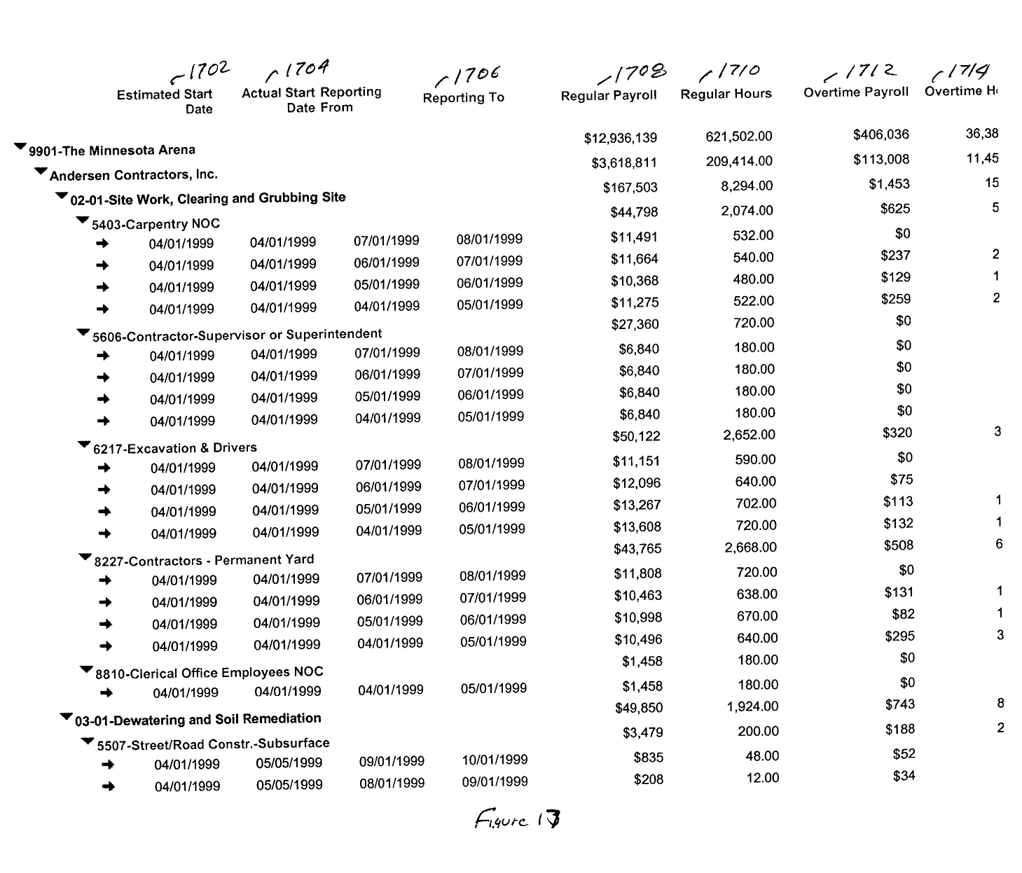

The payroll module 1140 includes estimated start date, actual start date, reporting dates, regular payroll, regular hours, overtime payroll, and overtime hours. FIG. 17 illustrates an example screen shot of information included within the payroll module 1140. For example, the payroll module 1140 includes an estimated start date 1702 an actual start reporting date from 1704 and to 1706, a regular payroll 1708, regular hours 1720, overtime payroll 1712 and overtime hours 1714, The experience modification module 1142 includes contact information and an experience modifier.

The experience modifier is relative to an industry average of 1.0. In other words, a contractor that has a good accident history would have an experience modifier less than 1.0; a contractor that ahs a poor accident history would have an experience modifier greater than 1.0.

The certificate expiration module 1148 tracks when the issued certificates of insurance expire for each party so that a new certificate can be issued if need be. The rate comparison module 1150 includes the industry average rate, the insurance company's rates, and the contractors normal rate. The policy issuance module 1152 is used to issue an insurance policy or certificate. In one example embodiment, the policy issuance module 1152 is in accordance with FIG. 8 and its associated description herein.

The resource module 1108 includes a resource sub-module 1160 and a state compliance module 1162.

The management module 1110 includes a project savings module 1170, a project tracking module 1172, and a project performance module 1174. The project savings module 1170 monitors the premiums collected versus the costs paid out. This enables an insurance company to track their gains and/or losses for a particular project. The project tracking module 1172 tracks the estimated costs versus actual costs, particularly for payroll. This information can be used by an insurance company to adjust insurance premiums and/or used by the owner to track cash flow and project status.

The above-described system 1100 is one example embodiment. Any number of variations are possible, including different modules, more modules, or less modules without departing from the scope of the claims.

It is noted that the data, or information, contained with the management system 1100 can be entered manually or received electronically. Also, given the information contained within the management system 1100, any number or variations of reports can be generated for the project. In addition, historical costs, rates, schedules, and so on, can be tracked for future use in establishing timelines, insurance rates, or any other suitable use.

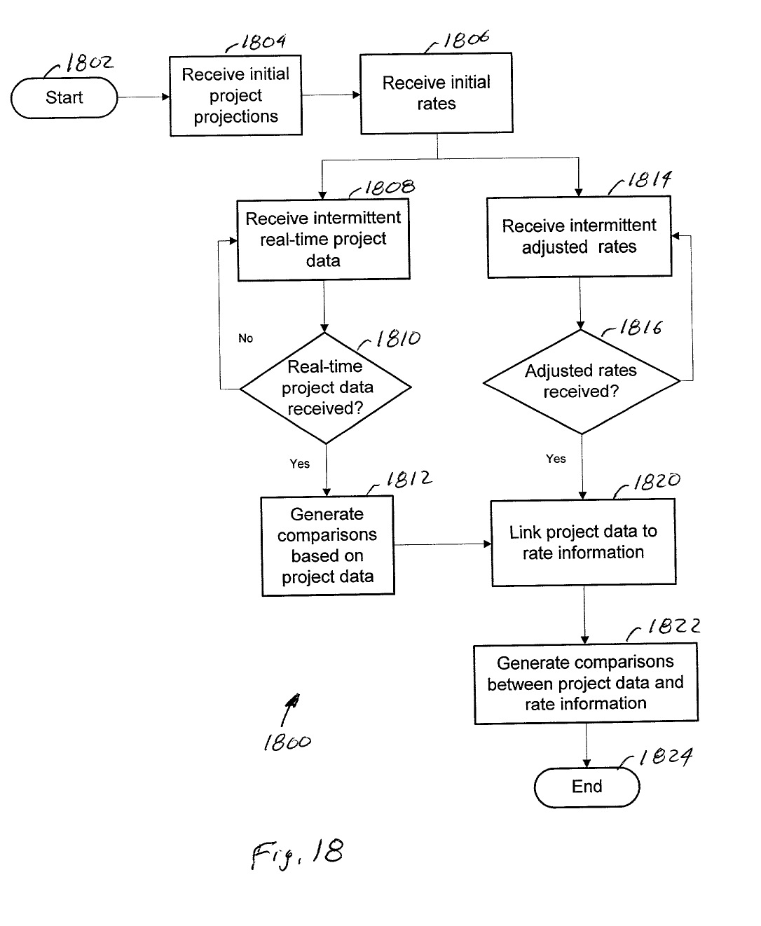

FIG. 18 illustrates an example operational flow for a management system 1800. FIG. 18 is a flow chart representing logical operations of the management system. Entrance to the operational flow begins at a flow connection 1802. A first receive module 1804 receives initial project projections, for example, estimated payroll. A second receive module 1806 receives initial rates, for example, benchmark rates. A third receive module 1808 receives intermittent real-time project data, for example, actual payroll. A real-time operation 1810 determines if the third receive module 1808 received any data. If the real-time operation 1810 determines that the receive module 1808 has not received any data, operational flow branches “NO” to the third receive module 1808. This operational flow continues in a loop until the real-time operation 1810 determines that the receive module 1808 has received data.

If the real-time operation 1810 determines that the third receive module 1808 has received data, operational flow branches “YES” to a first generate module 1812. The first generate module 1812 generates comparisons between the initial project projections received by the first receive module 1804 and the real-time project data received by the third receive module 1808. These comparisons might include, for example, a graph plotting estimated versus actual.

Referring back to the second receive module 1806, a fourth receive module 1814 receives intermittent adjusted rates. An adjusted operation 1816 determines if the fourth receive module 1814 received any intermittent adjusted rates. If the adjusted operation 1816 determines that the fourth receive module has not received any intermittent adjusted rates, operational flow branches “NO” to the fourth receive module. This operational flow continues in a loop until the adjusted operation 1816 determines that the fourth receive unit 1814 has received intermittent adjusted rates.

If the adjusted operation 1816 determines that the fourth receive unit has received intermittent adjusted rates, operational flow branches “YES” to a link module 1820. The link module 1820 links project data to rate information. A second generate module 1822 generates comparisons between the project data and the rate information. Operational flow ends at termination point 1824.

The operational flow described in connection with FIG. 18 may best be understood in terms of an application example. Operational flow begins at start point 1802. The first receive module 1804 receives an initial project projection of $1M in payroll. The second receive module 1806 receives a rate of 20%. The third receive module 1808 does not receive any intermittent real-time project data. The real-time operation 1810 determines that the third receive module 1808 has not received any intermittent real-time project data. Operational flow branches “NO” to the third receive module 1808.

In a second application example, operational flow proceeds as described above to the third receive module 1808. The third receive module 1808 receives intermittent real-time project data equal to $1.2M. The real-time operation 1810 determines that the third receive module 1808 received intermittent real-time project data, and operational flow branches “YES” to the first generate module 1812. The first generate module 1812 generates a comparison between the $1M and the $1.2M and plots this information on a graph.

The fourth receive module 1814 does not receive any information. The adjusted operation 1816 determines that the fourth receive module 1814 has not received any information, and operational flow branches “NO” to the fourth receive module 1814.

In a third application example, operational flow proceeds as described above to the fourth receive module 1814. The fourth receive module 1814 receives an intermittent adjusted rate of 25%. The adjusted operation 1816 determines that the fourth receive module 1814 received intermittent adjusted rate information, and operational flow branches “YES” to the link module 1820.

The link module 1820 links the project data, $1.0M and $1.2M, to the rate information, 20% and 25%. The second generate module 1822 generates comparisons between the project data and the rate information. This comparison might be that as the actual payroll exceeded the projected payroll, the rate increased proportionately.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A method of issuing an insurance policy for a wrap-up insurance program, the method comprising:
receiving initial data for a project;
receiving subsequent data for a plurality of parties; and
issuing an insurance policy for the plurality of parties;
wherein receiving initial data, receiving subsequent data, and issuing an insurance policy are performed by a single party.

2. A method according to claim 1, wherein:
receiving initial data includes receiving initial data for a project in a first computing system.

3. A method according to claim 2, wherein:
receiving subsequent data includes receiving subsequent data for a plurality of parties in the first computing system.

4. A method according to claim 3, wherein:
issuing an insurance policy includes issuing an insurance policy for the plurality of parties from the first computing system.

5. A method according to claim 1, further comprising:
entering initial data for a project in a first computing system and wherein receiving initial data includes receiving initial data for a project in a second computing system from the first computing system.

6. A method according to claim 5, further comprising:
entering subsequent data for a plurality of parties in a third computing system and wherein receiving subsequent data includes receiving subsequent data for a plurality of parties in the second computing system.

7. A method according to claim 6, wherein:
issuing an insurance policy for the plurality of parties includes issuing an insurance policy for the plurality of parties from a fourth computing system.

8. A method according to claim 7, wherein:
at least two of the first, second, third, and fourth computing systems are the same computing system.

9. A method according to claim 7, wherein:
the first computing system is a client computing system and the second computing system is a server computing system.

10. A method according to claim 9, wherein:
the third and fourth computing systems are client computing systems.

11. A computer program product readable by a computing system and encoding instructions for a computer process for issuing an insurance policy for a wrap-up insurance program, the computer process comprising:
receiving initial data for a project;
receiving subsequent data for a plurality of parties; and
issuing an insurance policy for the plurality of parties;
wherein receiving initial data, receiving subsequent data, and issuing an insurance policy are performed by a single party.

12. A computer program product according to claim 11, wherein:
receiving initial data includes receiving initial data for a project in a first computing system.

13. A computer program product according to claim 12, wherein:
receiving subsequent data includes receiving subsequent data for a plurality of parties in the first computing system.

14. A computer program product according to claim 13, wherein:
issuing an insurance policy includes issuing an insurance policy for the plurality of parties from the first computing system.

15. A computer program product according to claim 11, further comprising:
entering initial data for a project in a first computing system and wherein receiving initial data includes receiving initial data for a project in a second computing system from the first computing system.

16. A computer program product according to claim 15, further comprising:
entering subsequent data for a plurality of parties in a third computing system and wherein receiving subsequent data includes receiving subsequent data for a plurality of parties in the second computing system.

17. A computer program product according to claim 16, wherein:
issuing an insurance policy for the plurality of parties includes issuing an insurance policy for the plurality of parties from a fourth computing system.

18. A computer program product according to claim 17, wherein:
at least two of the first, second, third, and fourth computing systems are the same computing system.

19. A computer program product according to claim 17, wherein:
the first computing system is a client computing system and the second computing system is a server computing system.

20. A computer program product according to claim 19, wherein:
the third and fourth computing systems are client computing systems.

21. A system for issuing an insurance policy for a wrap-up insurance program, the system comprising:
a first receive module that receives initial data for a project;
a second receive module that receives subsequent data for a plurality of parties; and
an issuance module that issues an insurance policy for the plurality of parties;
wherein the first receive module, second receive module, and issuance module are controlled by a single system.

22. A method of managing project and insurance information, the method comprising:
receiving project information;
receiving insurance information;
linking the project information to the insurance information; and
generating a comparison in real-time relative to the receipt of project and insurance information.

23. A method according to claim 22 further comprising:
entering project information in a first computing system and wherein receiving project information includes receiving project information in a second computing system;
entering insurance information in a second computing system and wherein receiving insurance information includes receiving insurance information in the second computing system;
linking the project information includes linking the project information to the insurance information in the second computing system; and
generating a comparison includes generating a comparison in real-time relative to the receipt of project and insurance information in the second computing system.

24. A computer program product readable by a computing system and encoding instructions for a computer process for managing project and insurance information, the computer process comprising:
receiving project information;
receiving insurance information;
linking the project information to the insurance information; and
generating a comparison in real-time relative to the receipt of project and insurance information.

25. A system for managing project and insurance information, the system comprising:
a first receive module that receives project information;
a second receive module that receives insurance information;
a link module that links the project information to the insurance information; and
a generate module that generates a comparison in real-time relative to the receipt of project and insurance information.
